(19) United States
(12) Patent Application Publication
(10) Pub. No.: US 2017/0108033 A1
(43) Pub. Date: Apr. 20, 2017

(54) Androgynous Clamping System

(71) Applicant: Warren Scott Cochran, Los Gatos, CA (US)

(72) Inventor: Warren Scott Cochran, Los Gatos, CA (US)

(21) Appl. No.: 15/277,876

(22) Filed: Sep. 27, 2016

Related U.S. Application Data
(60) Provisional application No. 62/242,266, filed on Oct. 15, 2015.

(51) Int. Cl. F16C 11/06; F16B 2/18; F16M 13/02; B25H 1/00; F16B 2/06

(52) U.S. Cl. CPC F16C 11/06; B25H 1/0021; F16B 2/06; F16M 13/022; F16C 11/0685; F16B 2/185

(57) ABSTRACT

An apparatus capable of clamping onto other objects, as well as acting as either the male ball, female socket or both at the same time when paired with other similar apparatuses in a ball and socket joint system. By combining multiple apparatuses, various advanced versions can be produced and these versions allow the apparatus to be used as a constructing material for custom tools, supports and structures.

### CROSS REFERENCE TO RELATED APPLICATION

This application claims the benefit of U.S. Provisional Application No. 62242266, filed Oct. 15, 2015, which is incorporated herein in its entirety by reference.

### BACKGROUND

The human hand is often cited as humanity's most useful tool, though one that is usually limited to a single pair. Thus, the ability to mount and secure tools and other articles, keeping them organized and within reach when needed and freeing hands for other use when not, is both desirous and advantageous in a number of applications. Tools that allow for this are not only useful in and of themselves but can also enhance the utility of existing tools such as lamps and cameras.

While inventors have developed numerous clips and clamps, they are usually designed to work with a narrow range of objects and without the ability to interact and connect with similar tools. Thus they are able to attach articles together, but are not suitable for combining with one another to create a new, custom tool tailored for a specific task.

Information relevant to attempts to address these problems can be found in U.S. Pat. Nos. 7,852,200 and 7,207,616 and Chinese Patent Nos. 201059304 and 202829311. However, each one of these references suffer from one or more of the following disadvantages: limited mechanical advantage, minimal interconnectivity with similar tools and other objects, and narrow range of use.

For the foregoing reasons, there is need for a new style of clamp that uses spherical, androgynous connectors as their clamping structure. This design would allow the same piece to operate as the male ball, female socket, neither or both simultaneously. Such a clamp would not only be capable of binding and securing to a wide range of articles, but would also be capable of attaching to similar clamps in a wide array of combinations. Thus the same tool could be used for attaching and connecting and also building new tools and structures.

### SUMMARY

The present invention is directed to apparatuses and methods that satisfy these needs. This invention comprises:

according to various embodiments, a first hollow hemispherical structure, a second hollow hemispherical structure, a means for attaching these structures and a means for creating a clamping force between these two structures;

according to various embodiments, the means for creating a clamping force can be at least one elastic O-ring;

according to various embodiments, the means for creating a clamping force can be an expansion spring;

according to various embodiments, the means for creating a clamping force can be at least one torsion spring;

according to various embodiments, the means for attaching may possess at least one port, suitable for inserting optional attachments such as, but not limited to, spherical protrusions suitable for being clamped by spherical clamps;

according to various embodiments, the means for attaching may possess spherical protrusions suitable for being clamped by spherical clamps;

according to various embodiments, the hollow hemispherical structures may possess a means for attaching various inserts to enhance the clamp's ability to secure onto different objects;

according to various embodiments, the means for accepting inserts can be an array of ridges;

according to various embodiments, an apparatus combining multiple androgynous clamps into a single apparatus;

according to various embodiments, the means for attaching the two apparatuses together can be a pair of solid bodies, each attached to two hollow of the hemispherical structures;

according to various embodiments, the solid bodies can possess holes suitable for use with a screw and nut system, and the means for creating a clamping force can be a screw and nut system;

according to various embodiments, the nut can be spherically shaped;

according to various embodiments, the first and second solid bodies can possess guide channels for axles and the means for attaching can be two axles inserted into the guide channels;

according to various embodiments, one or more of the axles can be a screw and nut system;

according to various embodiments, at least one of the hollow hemispherical structures can be attached to a solid body by a means for pivoting;

according to various embodiments, a method for creating a ball and socket joint system comprising the steps of providing two or more apparatuses possessing the claimed invention, selecting either of the apparatuses to be the male ball and the other to be the female socket, opening the apparatus selected to be the female socket and inserting the apparatus selected to be the male ball into the open female socket, allowing the means for creating a clamping force to activate and allowing the hollow hemispherical structures of the apparatus selected to be the female socket to clamp down on the apparatus selected to be the male ball, creating a ball and socket joint system, and optionally using additional androgynous clamps in the same way to create more complex linkages of clamps.

### BRIEF DESCRIPTION OF THE DRAWINGS

FIG. 1 shows a side view of an apparatus embodying features of the present invention;

FIG. 2 shows a side view of an apparatus embodying features of the present invention, demonstrating the apparatus' ability to open;

FIG. 3 shows a perspective view from above of an apparatus embodying features of the present invention, in an open configuration;

FIG. 4 shows a perspective view from above of two apparatuses embodying features of the present invention interlocking and creating a ball and socket joint;

FIG. 5 shows a side view of an another version of an apparatus embodying features of the present invention;

FIG. 6 shows a side view of another version of an apparatus embodying features of the present invention, including exemplary designs for a screw and nut;

FIG. 7 shows a perspective view from above of an apparatus embodying features of the present invention;

FIG. 8 shows a perspective view from above of two apparatuses embodying features of the present invention interlocking and creating a ball and socket joint;

FIG. 9 shows a side view of another version of an apparatus embodying features of the present invention, including an exemplary location for an expansion spring;

FIG. 10 shows a side view of another version of an apparatus embodying features of the present invention, demonstrating its ability to open and close;

FIG. 11 shows a perspective view from above of an apparatus embodying features of the present invention;

FIG. 12 shows a side view of a portion of an apparatus embodying features of the present invention, including exemplary locations for a pivot system;

FIG. 13 shows a perspective view from above of an apparatus embodying features of the present invention, including axles consisting of a screw and nut system;

FIG. 14 shows a side view of a screw and nut system, capable of serving as an axle;

FIG. 15 shows a perspective view from above of an apparatus embodying features of the present invention, including exemplary locations for ports suitable for inserting additional attachments and spherical protrusions;

FIG. 16 shows a side view with partial cutouts, of an apparatus embodying features of the present invention;

FIG. 17 shows a perspective view from above of a portion of an apparatus embodying features of the present invention, including an exemplary design of a means for attaching inserts and an exemplary insert design;

FIG. 18 shows a perspective view from above of a portion of an apparatus embodying features of the present invention, including an exemplary insert inserted into the apparatus;

FIG. 19 shows a perspective view from below of an insert embodying feature of the present invention; and

FIG. 20 shows a side view of an insert embodying features of the present invention.

### DESCRIPTION

In the Summary above and the Description below, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments o the invention, and in the invention generally.

The term “comprises” and grammatical equivalents thereof are used herein to mean that other components, ingredients, steps etc. are optionally present. For example, an article “comprising” (or “which comprises”) components A, B, and C can consist of (i.e. contain only) components A, B, and C, or can contain not only components A, B, and C but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” or “at least one” means one or more than one. The term “at most” followed by a number is used herein to denote the end of a range ending with that number (which may be a range having one or zero as its lower limit, or a range having no lower limit, depending upon the variable begin defined). For example, “at most 4” or “at most four” means four or less than four, and “at most 40%” means 40% or less than 40%. When, in this specification, a range is given as “(a first number) to (a second number)” or “(a first number)−(a second number),” this means a range whose lower limit is the first number and whose upper limit is the second number. For example, 25 to 100 mm means a range whose lower limit is 25 mm, and whose upper limit is 100 mm.

### Definitions

“hemispherical” is a description of a shape or form that is generally hemispherical, but also possesses protrusions, holes and/or other deformities which prevent it from being perfectly hemispherical;

“spherical” is a description of a shape or form that is generally spherical but also possesses protrusions, holes and/or other deformities which prevent it from being perfectly spherical;

“ABS” is acrylonitrile butadiene styrene;

“TPU” is thermoplastic urethane;

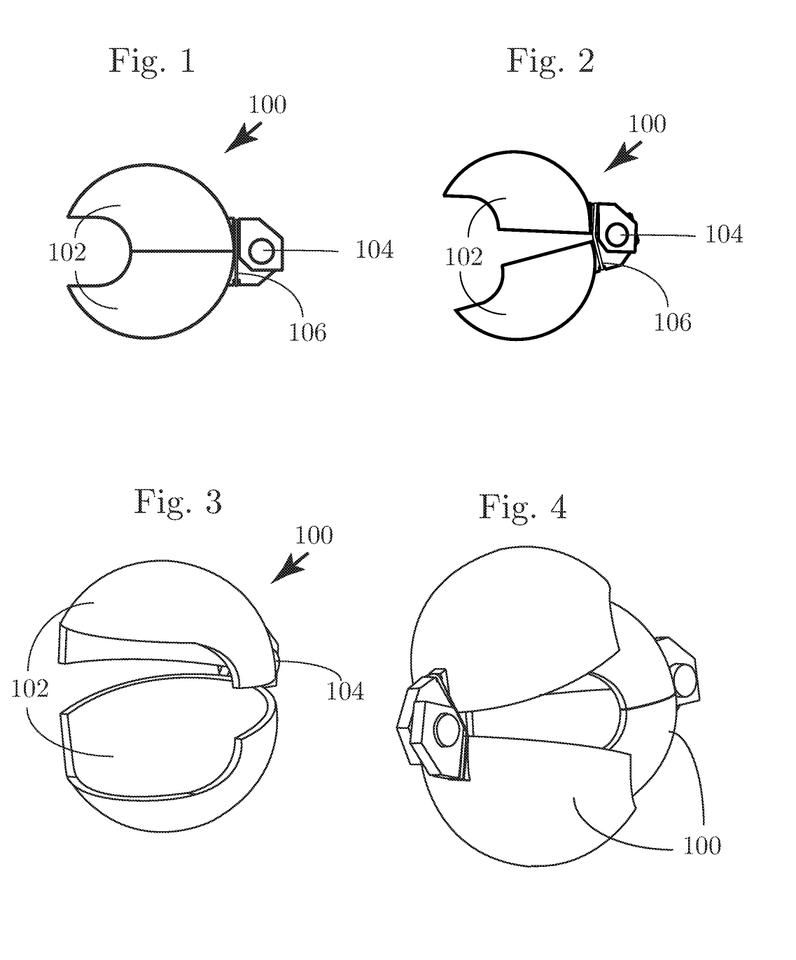

As shown in FIG. 1, an androgynous clamping system 100 comprises a first and second hollow hemispherical structure 102 a means for attaching 104 and means for creating a clamping force 106.

The first and second hemispherical structures 102 are aligned such that they form a hollow spherical structure. The means for attaching 104 can be an axle that allows the hemispherical structures 102 to open and close. As shown in FIG. 4, this allows the androgynous clamp 100 to function as either the male ball or female socket in a ball and socket joint system. The hemispherical structures 102 and means for attaching 104 can be made of any rigid material such as, but not limited to, ABS or aluminum.

The means for creating a clamping force 106 can comprise an elastic O-ring. The means for creating a clamping force 106 can be made of an elastic material such as, but not limited to, rubber.

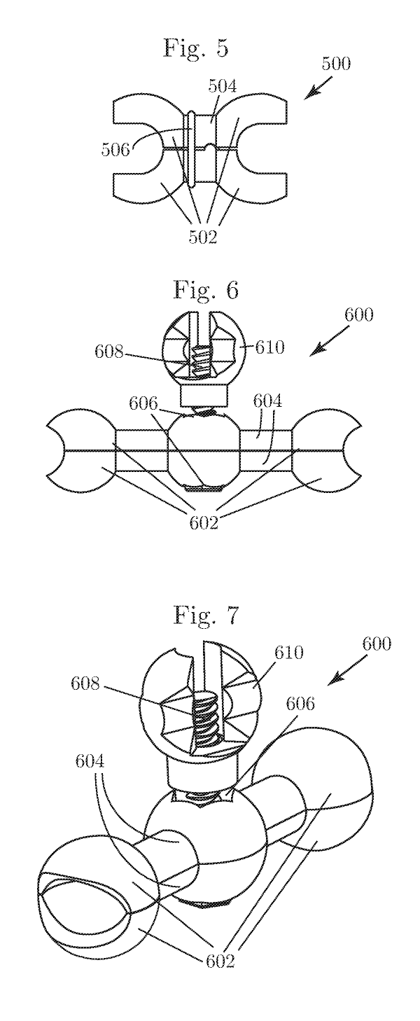

As shown in FIG. 5, an androgynous clamping system can additionally comprise a second pair of hollow hemispherical structures 502. The means for attaching 504 can comprise a pair of solid bodies that creates a dual sided clamp 500. The means for creating a clamping force 506 can comprise an elastic O-ring.

As shown in FIG. 6, the solid bodies 604 can possess holes 606 suitable for inserting a screw 608. The means for creating a clamping force can comprise a screw 608 and a nut 610 threaded onto the screw 608 such that turning the nut can increase or decrease the amount of clamping force directed to the the hollow hemispherical structures 602.

The nut 610 can be spherically shaped, allowing it to be grasped by spherically shaped clamps and serve as the male ball in a ball and socket joint system. The nut 610 can be made of rigid material such as, but not limited to, ABS or tool steel.

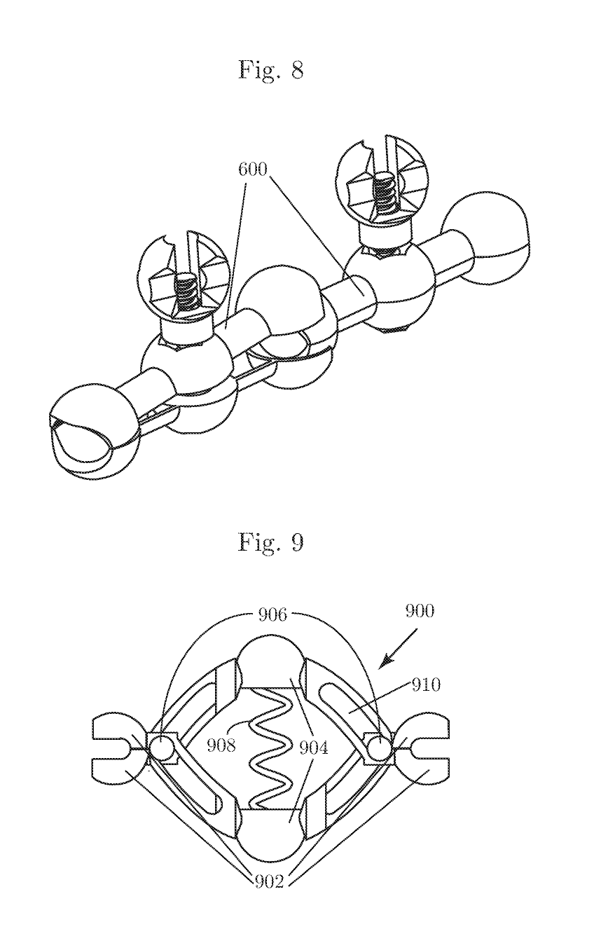

As shown in FIG. 8, two androgynous clamping systems 600 can be attached together in a ball and socket joint system to create a rigid and/or articulating structure. Either androgynous clamping system can serve as the male ball or female socket in the system and additional androgynous clamps can attached at this node as well. The unused spherical clamp ends can be used to attach the structure to other articles and objects.

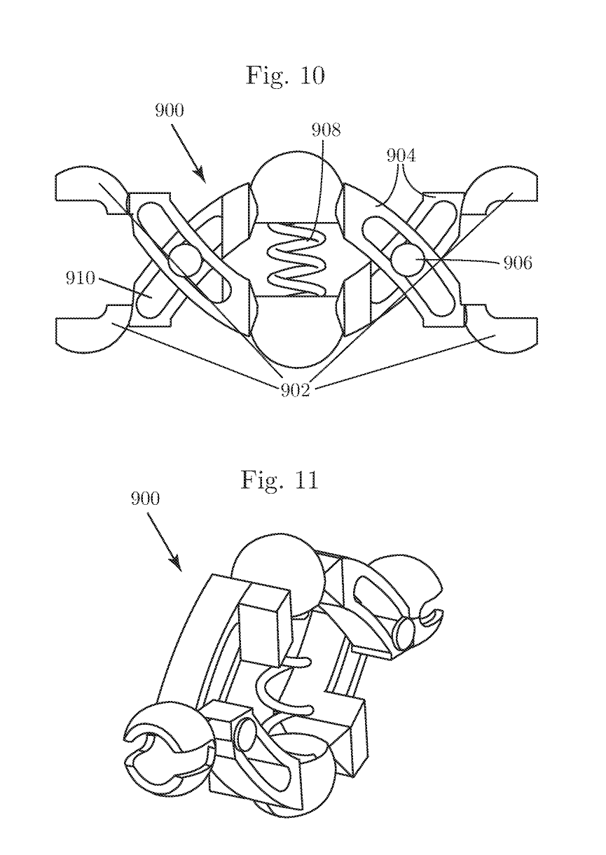

As shown in FIG. 9, the solid bodies 904 in an androgynous clamping system 900 can possess guide channels 910. By aligning these guide channels 910, a means for attaching 906, such as, but not limited to an axle system can be inserted, allowing the clamping system 900 to open and close as shown in FIG. 10. A means for creating a clamping force 908, can comprise an expansion spring that directs the hollow hemispherical structures 902 into one another.

The means for creating a clamping force can be made of material such as, but not limited to, spring steal or ABS.

As shown in FIG. 12, the hemispherical structures 1202 can be attached to a solid body 1204 by a means for pivoting 1206. The means for pivoting can be an axle, around which the hemispherical structures 1202 can rotate, increasing their ability to clamp onto objects. The means for pivoting can be constructed from a rigid material such as, but not limited to, aluminum or tool steel.

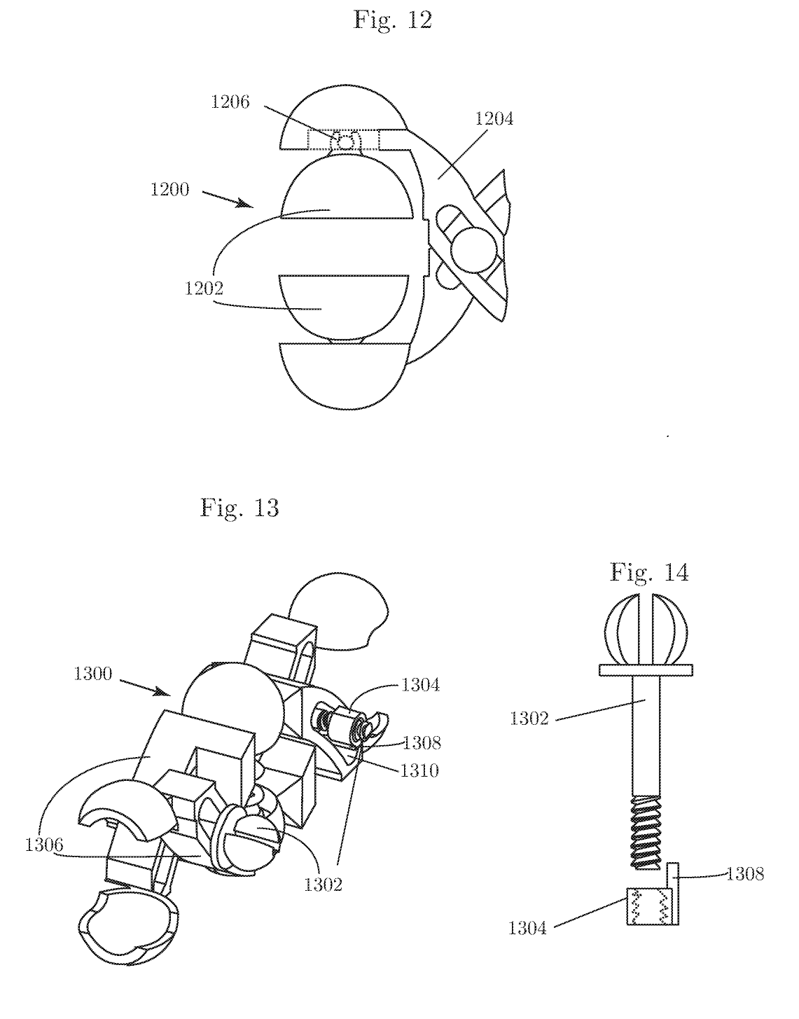

As shown in FIG. 13, a means for attaching can comprise a screw 1302 and nut 1304 inserted through a guide channel 1310. By tightening the screw, the solid bodies 1306 are forced together, hindering their movement through friction and locking the clamp into a desired position.

FIG. 14 shows an exemplary design of screw 1302 and nut 1304 in greater detail. The nut 1304 can possess an extrusion 1308, such that the nut's 1304 ability to rotate as the screw 1302 is turned is hampered by the extrusion making contact with the interior of the guide channel 1310.

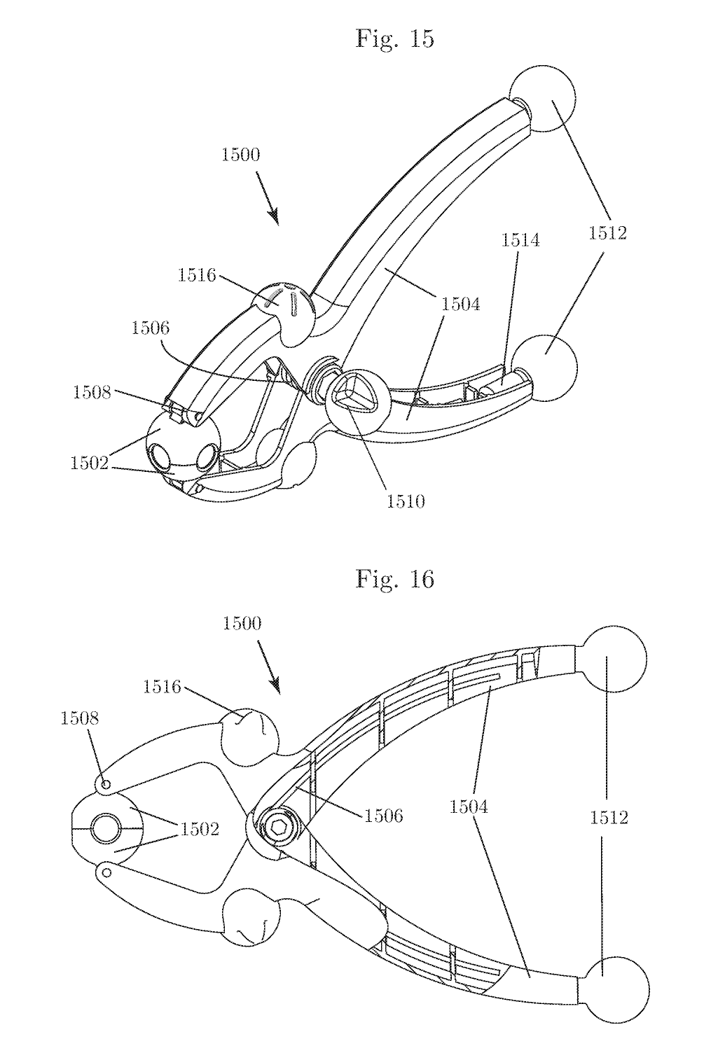

As shown in FIG. 15, an androgynous clamping system may comprise a first and second hemispherical structure 1502 attached to a means for attaching 1504 and secured to a means for creating a clamping force 1506.

The first and second hemispherical structures can be attached to the means attaching by a means for pivoting 1508 such as, but not limited to, an axle system. As shown in FIG. 16 the means for creating a clamping force 1506 can be a torsion spring, embedded in the means for attaching 1504.

The means for attaching 1504 can also possess ports 1514 embedded in the means for attaching 1504. Optional attachments 1512 can be inserted in the ports 1514. An example of an optional attachment 1512 is a spherical protrusion suitable for being clamped on by spherical clamps.

Additionally, the means for attaching 1504 can also possess spherical protrusions 1516 suitable for being clamped by other spherical clamping systems. The spherical protrusions can be molded as part of the means for attaching 1504.

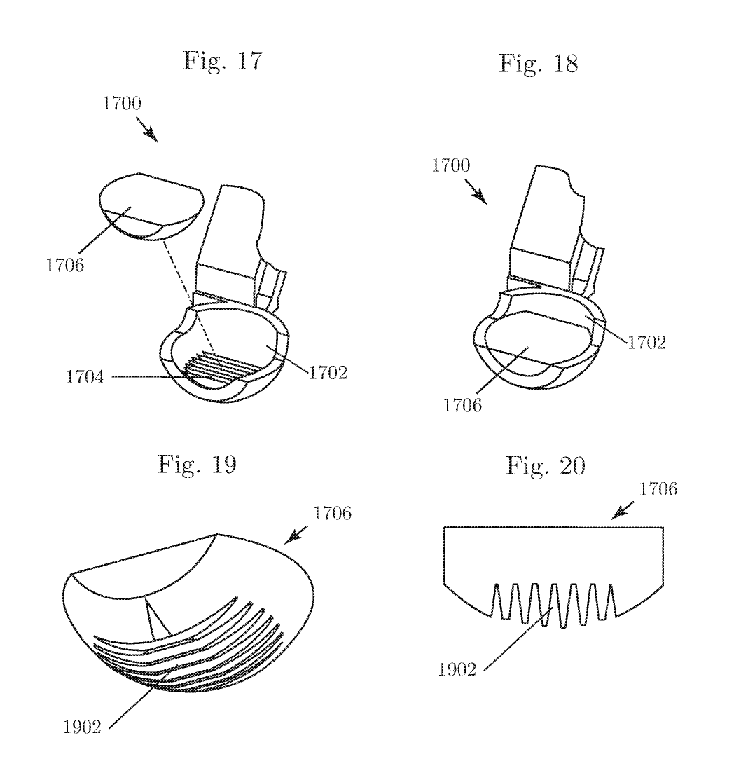

As shown in FIG. 17, a hollow hemispherical structure 1702 may possess a means for attaching inserts 1704. The means for attaching inserts may comprise an array of ridges into which an insert 1706 can be inserted. As shown in FIG. 18, the insert 1706 can be inserted into the hollow hemispherical structure 1702 improving the apparatus' ability to clamp onto certain objects. The means for attaching inserts may be made of a soft plastic such as, but not limited to, TPU.

As shown in FIG. 19, an insert 1706 may possess a shape suitable for mating with a hollow hemispherical structures' 1702 means for attaching inserts 1704. This shape can include an array of ridges 1902 shaped to fit an array of ridges on a hollow hemispherical structure. The insert can be made of soft plastic such as, but not limited to, TPU.

The previously described versions of the present invention have many advantages, including being constructed of high quality material, a high clamping strength, the ability to clamp and secure a wide variety of surfaces, shapes and articles, secondary fastening mechanisms, ease of use, including one handed use and reversibility in male/female socket design. The invention does not require that all the advantageous features and all the advantages be incorporated into every embodiment of the invention.

Although the present invention has been described in considerable detail with reference to certain preferred versions thereof, other versions are possible. For example, a version that tightens through a ratcheting mechanism and a version that provides user feedback when two clamps are attached at specific angles. Therefore, the spirt and scope of the appended claims should not be limited to the description of the preferred versions contained herein.

What is claimed is:

1. An apparatus comprising:
a first hollow hemispherical structure;
a second hollow hemispherical structure;
a means for attaching said first and second hollow hemispherical structure; and
a means for creating a clamping force;
wherein said first hollow hemispherical structure and said second hollow hemispherical structure are attached by said means for attaching said first and second hemispherical structure such that they form a spherically shaped assembly capable of opening and closing, and said means for creating clamping force is attached to said assembly such that said hemispherical structures clamp together.

2. The apparatus of claim 1 wherein, said means of creating a clamping force is at least one elastic O-ring.

3. The apparatus of claim 1 wherein, said means for creating a clamping force is at least one expansion spring.

4. The apparatus of claim 1 wherein, said means for creating a clamping force is at least one torsion spring.

5. The apparatus of claim 1 wherein, the means for attaching possess at least one port, suitable for inserting optional attachments such as, but not limited to, spherical protrusions suitable for being clamped by spherical clamps.

6. The apparatus of claim 1 wherein, said means for attaching possess at least one spherical protrusion, suitable for being clamped by spherical clamps.

7. The apparatus of claim 1 wherein, at least one of said hollow hemispherical structures possess a means for accepting inserts to enhance the apparatus' ability to clamp onto certain objects.

8. The apparatus of claim 7 wherein, said means for accepting inserts is an array of ridges.

9. An apparatus comprising:
a first apparatus as described in claim 1;
a second apparatus as described in claim 1;
a means for attaching said first and second apparatuses;
wherein said first and second apparatuses are attached by said means for attaching creating a multiple clamp assembly.

10. The apparatus of claim 9 wherein, said means for attaching said first and second apparatuses comprises: a first solid body connecting said first apparatus's first hollow hemispherical structure and said second apparatus's first hollow hemispherical structure, a second solid body connecting said first apparatus's second hollow hemispherical structure and said second apparatus's second hollow hemispherical structure.

11. The apparatus of claim 10 wherein, at least one of said hollow hemispherical structures is attached to a said solid body by a means for pivoting.

12. The apparatus of claim 10 wherein, said first and second solid bodies each possess a hole and said means for creating a clamping force is a screw inserted through both said holes and a nut threaded onto the screw.

13. The apparatus of claim 12, wherein said nut is spherically shaped.

14. The apparatus of claim 10 wherein, said first and second solid bodies each possess two guide channels and are aligned along these guide channels forming two pairs of aligned guide channels, and are attached together by a first and second axle, said first axle being inserted through the one said pair of aligned guide channels and said second axle being inserted into the other said pair of aligned guide channels.

15. The apparatus of claim 14 wherein, at least one of said axles comprises a screw and nut.

16. A method for creating a ball and socket joint system comprising the following steps:
A) providing two or more apparatuses possessing the features of the apparatus described in claim 1;
B) selecting either of said apparatuses to be the male ball and the other to be the female socket;
C) opening said apparatus selected to be the female socket and inserting said apparatus selected to be the male ball into said open female socket;
D) allowing said means for creating a clamping force to activate and allowing said hollow hemispherical structures of said apparatus selected to be the female socket to clamp down on said apparatus selected to be the male ball;
whereby, a ball and socket joint system will be created.

17. The method of claim 16, comprising the additional steps of:
A) providing at least one additional apparatuses possessing the features of the apparatus described in claim 1;
B) opening at least one of said additional apparatuses and placing said additional apparatuses' hollow hemispherical structures over said created ball and socket joint system and allowing it to clamp down;
whereby a ball and socket joint system will be created wherein the same piece will be acting as a male ball and female socket simultaneously.
